(19) United States
(12) Patent Application Publication
(10) Pub. No.: US 2026/0244867 A1
(43) Pub. Date: Aug. 20, 2026

(54) Dual Modes for Large Language Model Inference

(71) Applicant: MediaTek Singapore Pte. Ltd., Singapore (SG)

(72) Inventors: Jia Yao Christopher Lim, Singapore (SG); Kelvin Kae Wen Teh, Singapore (SG); Po-Yen Lin, Hsinchu City (TW); Chia-Wei Hsu, Hsinchu City (TW); Yu-Lung Lu, Hsinchu City (TW); Hung-jen Chen, Hsinchu City (TW); Chung-Li Lu, Hsinchu City (TW); Wai Mun Wong, Singapore (SG); Deep Yap, Singapore (SG); Jung Hau Foo, Singapore (SG); Timothy Jun Jie Lee, Singapore (SG); Ziang Yang, Singapore (SG)

(21) Appl. No.: 19/057,000

(22) Filed: Feb. 19, 2025

(51) Int. Cl. G06F 40/289; G06F 40/284

(52) U.S. Cl. CPC G06F 40/289; G06F 40/284

(57) ABSTRACT

Fixed-shaped large language models (LLMs) are generated to perform dual-mode inference. First, a base model of dynamic shapes is quantized. A first LLM and a second LLM are generated from the base model after the quantizing. The first LLM has a fixed input shape greater than one, and the second LLM has a fixed input shape of one. The first LLM and the second LLM have the same network structure and the same weights. The layers of the network structure are grouped into multiple chunks. The number of layers in each chunk is determined by a size limit of a target device memory that loads the chunks during inference. The first LLM and the second LLM are compiled for inference time execution of an LLM task on a target device. The compiling incorporates information of the chunks.

### TECHNICAL FIELD

Embodiments of the invention relate to the use of large language models (LLMs) having different input shapes to perform dual-mode inference for improved performance.

### BACKGROUND OF THE INVENTION

Recent advancement in Large Language Models (LLMs) has enabled a growing number of use cases. For example, an LLM can provide a chatbot service, where a user prompts the LLM with a question and the LLM generates a response. As another example, an LLM can provide a summarization service, where a user prompts the LLM with a long article, and the LLM generates a summary of the article. LLMs are typically based on transformer models. A transformer model can process multiple input tokens concurrently and predict the next most-likely token. An LLM can use past values to predict future values. At inference time, an LLM generates a response to a prompt iteratively, one output token at a time. In each iteration cycle, the LLM appends the output token to the input tokens to predict the next output token. As the only update (i.e., new data) in each iteration cycle is the output token, re-computations involving the prior input tokens incur unnecessary overhead. Thus, there is a need for developing cost-efficient methods for LLM operations.

### SUMMARY OF THE INVENTION

In one embodiment, a method is provided for generating fixed-shaped LLMs to perform dual-mode inference. The method includes the steps of quantizing a base model of dynamic shapes, and generating a first LLM and a second LLM from the base model after the quantizing. The first LLM has a fixed input shape greater than one, and the second LLM has a fixed input shape of one. The first LLM and the second LLM have the same network structure and the same weights. The method further includes the step of grouping the layers of the network structure into multiple chunks. The number of layers in each chunk is determined by a size limit of a target device memory that loads the chunks during inference. The method further includes the step of compiling the first LLM and the second LLM are compiled for inference time execution of an LLM task on a target device. The compiling incorporates information of the chunks.

In another embodiment, a system is provided for generating fixed-shaped LLMs that perform dual-mode inference. The system includes processors and a memory coupled to the processors. One or more of the processors are operative to perform the aforementioned method.

Other aspects and features will become apparent to those ordinarily skilled in the art upon review of the following description of specific embodiments in conjunction with the accompanying figures.

### BRIEF DESCRIPTION OF DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 is a block diagram illustrating dual-mode inference using two fixed-shaped LLMs according to some embodiments.

FIG. 2 is a diagram illustrating a process for generating two fixed-shaped LLMs according to one embodiment.

FIG. 3 is a block diagram illustrating inference operations according to one embodiment.

FIG. 4 is a diagram illustrating an operation of grouping network layers into chunks according to one embodiment.

FIG. 5 is a flow diagram illustrating a method for generating two fixed-shaped LLMs that perform dual-mode inference according to one embodiment.

FIG. 6 is a flow diagram illustrating a method for dual-mode inference using two fixed-shaped LLMs according to one embodiment.

FIG. 7 is a block diagram illustrating a system operative to generate two fixed-shaped LLMs according to one embodiment.

FIG. 8 is a block diagram illustrating a device operative to perform dual-mode inference using two fixed-shaped LLMs according to one embodiment.

### DETAILED DESCRIPTION OF THE INVENTION

In the following description, numerous specific details are set forth. However, it is understood that embodiments of the invention may be practiced without these specific details. In other instances, well-known circuits, structures, and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

The disclosure herein describes a method and system for providing two fixed-shaped LLMs that have different input shapes and share a common cache to perform dual-mode inference. The two fixed-shaped LLMs include a prompt LLM and a generative LLM, which operate in a prompt mode and a generative mode, respectively. Both LLMs have the same network structure (e.g., the same graph representation of the network layers) and have the same weights. The generative LLM has an input shape of one token, and the prompt LLM has a larger input shape (e.g., 128, 256, 1024, or the like) than that of the generative LLM. As used herein, the term “input shape” refers to the input token size (i.e., the number of input tokens) that an LLM can concurrently receive and process at each layer. A token is a basic unit of natural language that an LLM processes. All inputs in natural language are converted to tokens before inputting into the LLMs.

The use of fixed-shaped LLMs with different input shapes for prompts and responses can significantly improve inference performance. For highly parallel processors and accelerators, supporting dynamic tensor shapes at inference time can have a negative impact on performance due to the shape-adjustment overhead. On the other hand, using a single fixed-shaped LLM can cause performance degradation no matter what input shape is chosen. If a large input shape is chosen, the generative mode performance will suffer from redundant computations during every inference forward pass, resulting in poor latency and power. If a small input shape is chosen, the prompt mode will take a very long time to complete all input tokens. If a median input shape is chosen, both the prompt and generative modes will not be able to run at the optimal performance. As will be described below, the large input shape of the prompt LLM speeds up the prompt processing, and the one-token input shape of the generative LLM in combination with the cached information reduces unnecessary re-computations. Thus, inference performance can be improved with respect to not only response latency but also power consumption.

The use of two fixed-shaped LLMs are described throughout the following description. In some alternative embodiments, more than two fixed-shaped LLMs may be used for performing dual-mode LLM operations. For example, one prompt LLM may be used in the prompt mode to produce the first output token, and multiple generative LLMs may be used in the generative mode to produce subsequent output tokens.

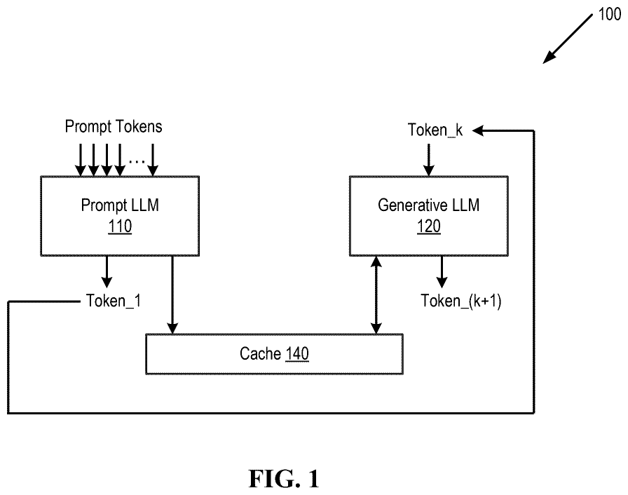

FIG. 1 is a block diagram illustrating dual-mode inference using two fixed-shaped LLMs according to one embodiment. The two fixed-shaped LLMs include a prompt LLM 110 and a generative LLM 120. The prompt LLM 110 is non-autoregressive, and the generative LLM 120 is autoregressive. During the prompt mode operation, the prompt LLM 110 processes all of the input tokens in a prompt (a.k.a. prompt tokens) and generates a first output token (Token_1). The intermediate representation during the generation of Token_1 is stored in a cache 140. An intermediate representation is a data structure used internally by an LLM to capture the evolving understanding of an input sequence as the input sequence passes through the LLM layers. The generative LLM 120 receives Token_1 and the cached information, and generates a second output token (Token_2). The generative LLM 120 performs an iterative process. In each iteration, the generative LLM 120 uses the output token (Token_k) from the previous iteration as the input token as well as the cached information to generate a next output token (Token_(k+1)). The past processed input tokens and output tokens are accumulated in the cache. The iterative process continues until a stopping criterion is met (e.g., a maximum number of iterations is reached, or another predetermined criterion).

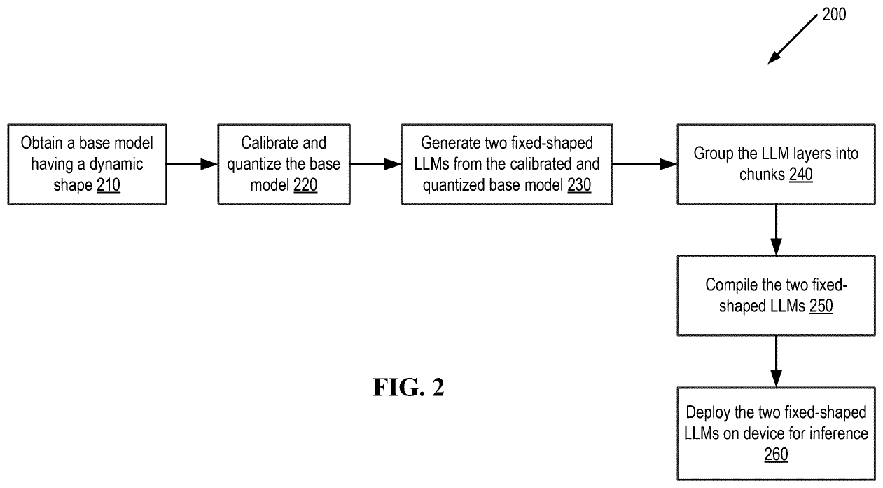

FIG. 2 is a block diagram illustrating a process 200 for generating two fixed-shaped LLMs according to one embodiment. The process 200 starts with a computer system receiving a base model at step 210, where the base model is a pre-trained LLM that supports dynamic shapes. More specifically, the base model can handle any input token size at the inference time without requiring the input token size be pre-defined. At step 220, the base model is calibrated and quantized. In one embodiment, a calibration dataset may be fed into the base model, and the output distribution of the base model is adjusted to reduce biases and other inaccuracies. Moreover, the weights and activations of the base model are quantized from a floating-point representation to an integer representation with fewer bits. The calibration and quantization may be performed according to any known calibration and quantization schemes. At step 230, the computer system generates two fixed-shaped LLMs from the post-quantized base model. Both fixed-shaped LLMs have the same calibration and quantization as the base model. In an alternative embodiment, the two fixed-shaped LLMs may be calibrated individually during quantization. For example, the calibration dataset may be partitioned into two subsets of calibration data, one subset containing prompt-only information, and the other containing response-only information. The prompt model can be quantized using the prompt-only calibration subset, and the generative model can be quantized using the response-only calibration subset. In this alternative embodiment, the prompt model and the generative model can have different quantization parameters.

In one embodiment, a shape-fixer module in the computer system specifies the input shape of each fixed-shaped LLM (e.g., 128 for the prompt LLM 110 and one for the generative LLM 120). The shape-fixer module may set the input shape by propagating the input shape throughout all the operators in all the layers of each LLM. Additionally, the shape-fixer module also determines the cache size needed for storing the intermediate representation at each layer of each fixed-shaped LLM, and sets the cache size throughout each layer of each LLM. At step 240, the shape-fixer module groups the layers of each fixed-shaped LLM into chunks. It is noted that the base model, the prompt LLM 110, and the generative LLM 120 have the same network structure, and, therefore, the same number of layers. For example, the network structure may have 32 layers, and the layers may be grouped into four chunks with each chunk containing eight layers. When all 32 layers are in one chunk, the entire LLM would need to be stored in one contiguous segment of the target device memory (e.g., DRAM) at inference time. This may not be feasible for a target device such as an edge device. By grouping the LLM layers into multiple chunks, each chunk may be loaded into a separate memory segment that has contiguous addresses at runtime (i.e., inference time). In some scenarios, a customer of the LLMs (e.g., a target device manufacturer) may request a chunk size limit, and the shape-fixer module can determine the grouping of the layers for each fixed-shaped LLM according to the chunk size limit.

Chunking each LLM before compile time enables the compiler to add information of the chunks into the compiled code, such as information of the starting address (which has not been allocated with memory), the size of each chunk, and the identifiers of the layers that are grouped into each chunk. The LLM chunking benefits inference performance even though initializing multiple memory segments at runtime may incur some overhead. One benefit of LLM chunking is the flexibility in memory allocation at inference time. Another benefit is the speedup in inference performance as the chunking information in the compiled code can simplify runtime memory management and memory allocation.

At step 250, the computer system compiles the two fixed-shaped LLMs for a target device. Each LLM is compiled according to the input shape and cache size parameters previously set by the shape-fixer module. Moreover, each LLM is compiled according to the information of the chunks. After the compilation at step 260, the compiled LLMs can be deployed on a target device for dual-mode inference operations. As the two LLMs share the same weights, the target device memory may store one set of weights to be used by both LLMs to reduce the required memory size.

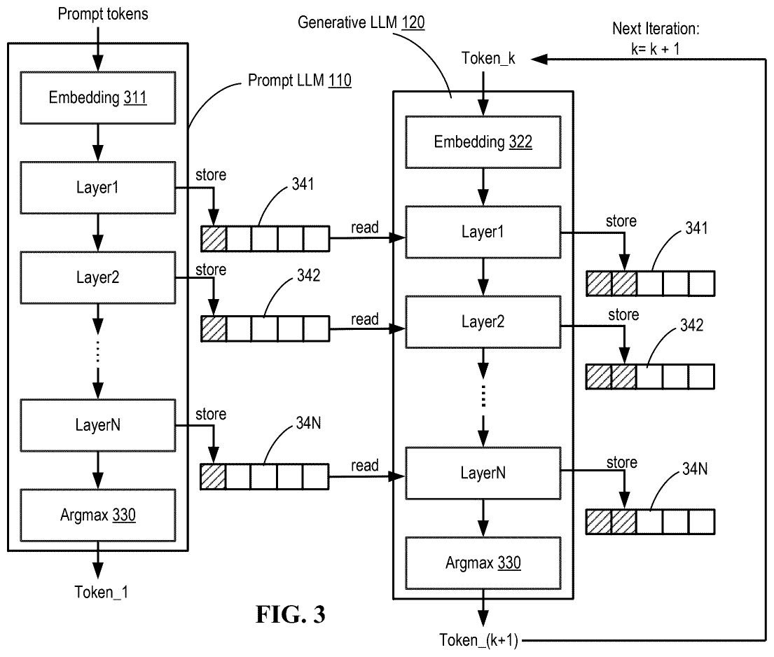

FIG. 3 is a diagram illustrating the inference time operations according to one embodiment. The prompt LLM 110 includes an embedding layer 311, which generates embeddings of the prompt tokens. Following the embedding layer 311 is a series of layers (e.g., layer1, layer2, . . . , layerN), with each layer processing a corresponding input and generating an output for the next layer. In one embodiment, each layer may be a transformer layer known in the field of neural networks. Each layer has a corresponding cache (which may be a portion of a cache) 341, 342, . . . , 34N into which the layer stores its output (e.g., the intermediate representation). The leftmost square in the cache with the slanted-line pattern represents the cache portion that stores the intermediate representation of the corresponding layer. An argmax function 330 is applied to the output distribution of layerN to generate the first output token (Token_1).

Subsequently, Token_1 is passed from the prompt LLM 110 to the generative LLM 120. The generative LLM 120 includes an embedding layer 322, which generates an embedding of the single input token. Following the embedding layer 322 is a series of layers (e.g., layer1, layer2, . . . , layerN), with each layer processing a corresponding input and reading the cached information from a corresponding cache to generate a corresponding output. Each layer also stores its output into the corresponding cache (represented by the second square with slanted-line pattern). More specifically, each layer of the generative LLM 120 obtains prior cached intermediate representations and generates a subsequent set of intermediate representations to be concatenated to the prior cached intermediate representations. The argmax function 330 is applied to the output of layerN to generate the second output token (Token_2). The generative LLM 120 iterates the process of token generation until a stopping criterion is met.

For example, if the prompt LLM 110 is provided with 128 prompt tokens, it will predict the next token (the 129^{th} token) as the first output token. Then the 129^{th} token and the cache of the first 128 tokens (in the form of intermediate representations) are input into the generative LLM 120 to predict the 130^{th} token. Then the 130^{th} token will be re-input into the generative LLM 120 together with the cached information of the first 129 tokens to predict the 131^{st} token, and so on.

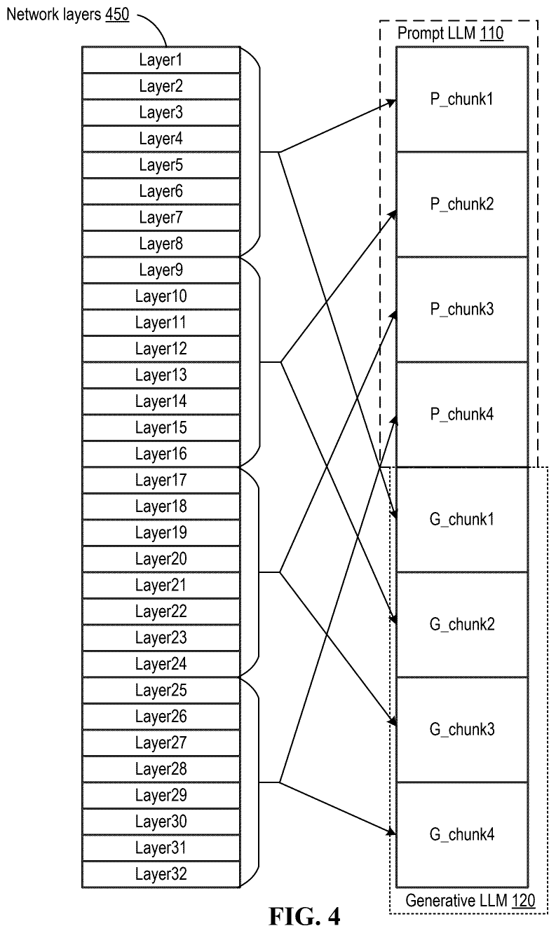

FIG. 4 is a diagram illustrating an operation of grouping network layers 450 into chunks according to one embodiment. As mentioned before regarding step 240 in FIG. 2, each chunk may be allocated and loaded into a different part of the memory. In this example, there are 32 layers grouped into four chunks for each of the two LLM 110 and 120, and each chunk includes eight layers. In an alternative embodiment, the chunks may have different numbers of layers. Using the example of 32 layers, the network layers 450 may be partitioned into three 10-layer chunks followed by a 2-layer chunk. There are benefits to this unevenly-distributed chunking, such as when a system uses an “early exit” method to terminate the data flow early (e.g., by skipping the last chunk) in order to reduce computations. In one embodiment, the number of layers in each chunk may be individually configurable. That is, the system may set the number of layers in each chunk individually to a configurable number.

During inference in the prompt mode, the four chunks of the prompt LLM 110 are loaded into the memory. The four chunks of the generative LLM 120 may be loaded into the memory after the completion of the prompt mode. In one embodiment, the chunk size (as well as the number of chunks) is determined based on the target device's memory constraints when the two LLMs 110, 120 are generated. The chunk size together with the parameters (including the input shape per layer and the cache size per layer) of the two LLMs 110, 120 are fed into the compiler at compile time.

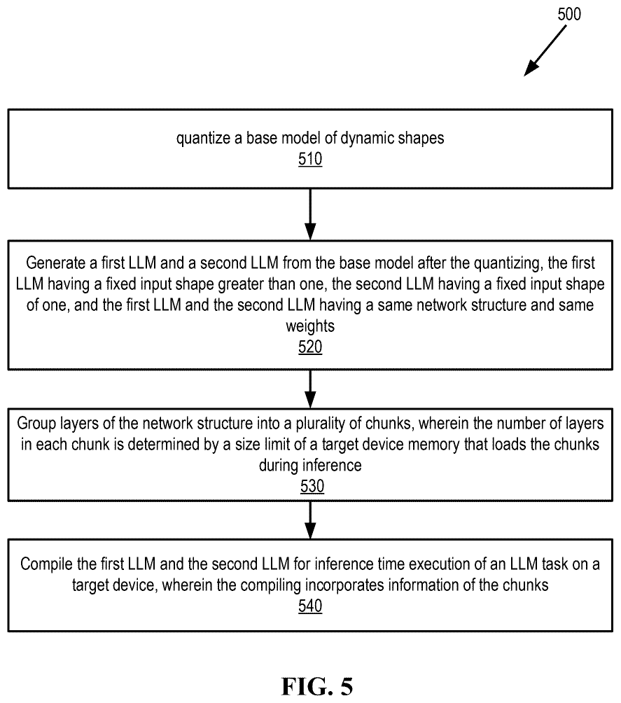

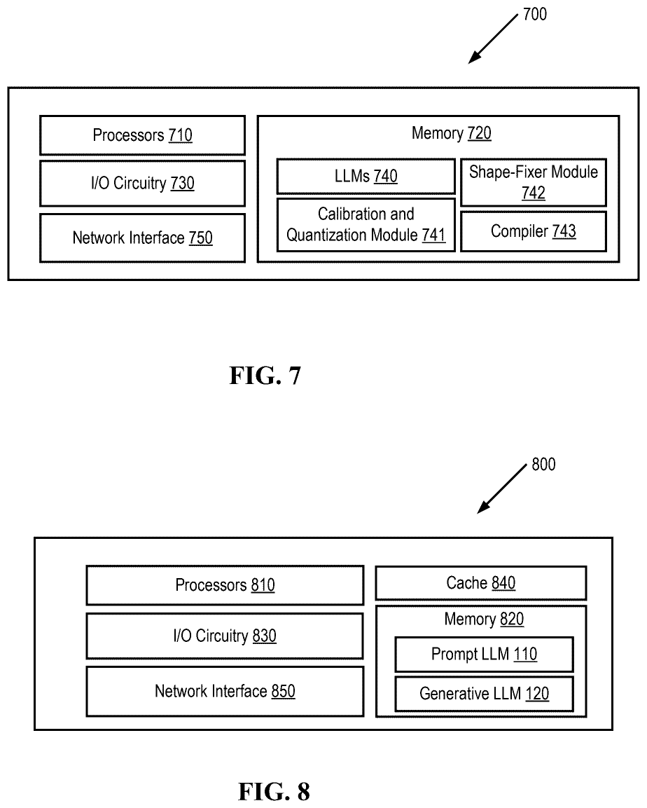

FIG. 5 is a flow diagram illustrating a method 500 for generating two fixed-shaped LLMs that perform dual-mode inference according to one embodiment. The method 500 may be performed by a system such as the system 700 in FIG. 7, or another computing system. In one embodiment, the method 500 starts with step 510 in which the system quantizes a base model of dynamic shapes. At step 520, the system generates a first LLM and a second LLM from the base model after the quantizing. The first LLM has a fixed input shape greater than one, the second LLM has a fixed input shape of one, and the first LLM and the second LLM have the same network structure and the same weights. At step 530, the system groups layers of the network structure into a plurality of chunks. The number of layers in each chunk is determined by a size limit of a target device memory that loads the chunks during inference. At step 540, the system compiles the first LLM and the second LLM for inference time execution of an LLM task on a target device. The compiling incorporates the information of the chunks.

In one embodiment, when generating the first LLM and the second LLM, the computer system sets the fixed input shape of the first LLM to N at each layer of the network structure, N>1, sets the fixed input shape of the second LLM to 1 at each layer of the network structure, and compiles the first LLM and the second LLM. The compiling further incorporates respective input shapes of the first LLM and the second LLM at each layer of the network structure. In one embodiment, the computer system further sets respective cache sizes of the first LLM and the second LLM at each layer of the network structure for storing intermediate representations during inference. In one embodiment, the information of the chunks includes identifiers of the layers that are grouped into each chunk. In one embodiment, the computer system may set the number of layers in each chunk individually to a configurable number. In one embodiment, the weights and activations of the base model are quantized from floating points to integers. In one embodiment, the base model is calibrated prior to generating the first LLM and the second LLM. In another embodiment, the first LLM and the second LLM are calibrated individually.

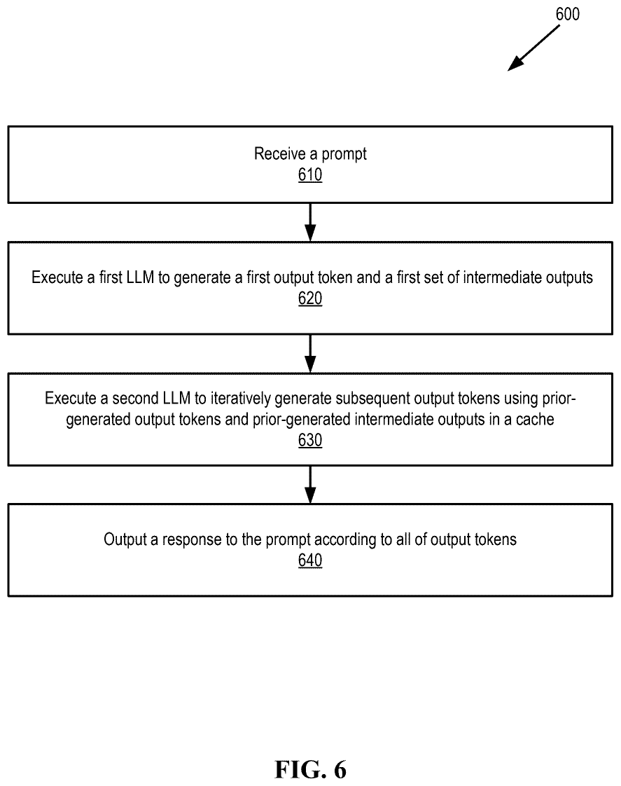

FIG. 6 is a flow diagram illustrating a method 600 for dual mode inference using two fixed-shaped LLMs according to one embodiment. The method 600 may be performed by a device such as the device 800 in FIG. 8, or another computing/communication device. Referring also to FIG. 1, the device stores a first LLM and a second LLM, such as the prompt LLM 110 and the generative LLM 120, respectively. In one embodiment, the method 600 starts with step 610 in which the device receives a prompt. In response to the prompt, the device at step 620 executes a first LLM to generate a first output token and a first set of intermediate representations. The device at step 630 executes a second LLM to iteratively generate subsequent output tokens using prior-generated output tokens and prior-generated intermediate representations in a cache. The device at step 640 outputs a response to the prompt according to all of the output tokens.

In one embodiment, the first LLM generates a first output token and the second LLM generates subsequent output tokens during inference. In one embodiment, the first LLM generates a first set of intermediate representations to store in a cache for access by the second LLM. The first set of intermediate representations includes an output from each layer of the first LLM. In one embodiment, when generating each subsequent output token, the second LLM obtains prior cached intermediate representations and generates a subsequent set of intermediate representations to be concatenated to the prior cached intermediate representations.

FIG. 7 illustrates an example of a system 700 operative to generate two fixed-shaped LLMs according to one embodiment. In this example, the system 700 includes multiple processors 710 such as a central processing unit (CPU), a graphics processing unit (GPU), a neural processing unit (NPU), a multimedia processor, a digital signal processor (DSP), and other general-purpose and/or special-purpose processing circuitry. The processors 710 may perform the operations of method 500 in FIG. 5.

The system 700 further includes a memory 720. The memory 720 may include one or more of a dynamic random-access memory (DRAM) device, a static RAM (SRAM) device, a flash memory device, and/or other volatile or non-volatile memory devices. In one embodiment, the memory 720 stores instructions executable by the processors 710 to generate fixed-shaped LLMs 740, such as the prompt LLM 110 and the generative LLM 120 in FIG. 1. The memory 720 may further include a calibration and quantization module 741, a shape-fixer module 742, and a compiler 743 to perform the operations described in connection with FIG. 2. Although memory 720 is shown as one block in FIG. 7, it is understood that memory 720 may include multiple memory devices at multiple memory hierarchies.

The system 700 may further include I/O circuitry 730 to receive input and display output. In one embodiment, the system 700 may further include network interfaces 750 for accessing wired and/or wireless networks. It is understood that the system 700 is simplified for illustration; additional hardware and software components are not shown.

FIG. 8 illustrates an example of a device 800 operative to dual-mode inference using two fixed-shaped LLMs according to one embodiment. In this example, the device 800 includes multiple processors 810 such as a CPU, a GPU, an NPU, a multimedia processor, a DSP, and other general-purpose and/or special-purpose processing circuitry. The processors 810 may perform the operations of method 600 in FIG. 6.

The device 800 further includes a memory 820 for storing the prompt LLM 110 and the generative LLM 120, and a cache 840 for storing the intermediate representations of the LLMs. The memory 820 may include one or more of a DRAM device, a flash memory device, and/or other volatile or non-volatile memory devices. The cache 840 may include an SRAM device, or other types of on-chip fast memory. In one embodiment, the memory 820 stores instructions executable by the processors 810 to perform inference using the prompt LLM 110 and the generative LLM 120. Although memory 820 is shown as one block in FIG. 8, it is understood that memory 820 may include multiple memory devices at multiple memory hierarchies.

The device 800 may further include I/O circuitry 830 to receive input and display output. In one embodiment, the device 800 may further include network interfaces 850 for accessing wired and/or wireless networks. It is understood that the device 800 is simplified for illustration; additional hardware and software components are not shown.

The operations of the flow diagrams of FIG. 5 and FIG. 6 have been described with reference to the exemplary embodiments of FIG. 7 and FIG. 8. However, it should be understood that the operations of the flow diagrams of FIG. 5 and FIG. 6 can be performed by embodiments of the invention other than the embodiments of FIG. 7 and FIG. 8, and the embodiments of embodiments of FIG. 7 and FIG. 8 can perform operations different than those discussed with reference to the flow diagrams. It is understood that the order of operations shown in the flow diagrams of FIG. 5 and FIG. 6 is a non-limiting example. Alternative embodiments may perform the operations in a different order, combine certain operations, overlap certain operations, etc.

Various functional components or blocks have been described herein. As will be appreciated by persons skilled in the art, the functional blocks will preferably be implemented through circuits (either dedicated circuits or general-purpose circuits, which operate under the control of one or more processors and coded instructions), which will typically comprise transistors that are configured in such a way as to control the operation of the circuitry in accordance with the functions and operations described herein.

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is

1. A method for generating fixed-shaped large language models (LLMs) that perform dual-mode inference, comprising:
quantizing a base model of dynamic shapes;
generating a first LLM and a second LLM from the base model after the quantizing, the first LLM having a fixed input shape greater than one, the second LLM having a fixed input shape of one, and the first LLM and the second LLM having a same network structure and same weights;
grouping layers of the network structure into a plurality of chunks, wherein the number of layers in each chunk is determined by a size limit of a target device memory that loads the chunks during inference; and
compiling the first LLM and the second LLM for inference time execution of an LLM task on a target device, wherein the compiling incorporates information of the chunks.

2. The method of claim 1, wherein generating the first LLM and the second LLM further comprises
setting the fixed input shape of the first LLM to N at each layer of the network structure, N>1;
setting the fixed input shape of the second LLM to 1 at each layer of the network structure; and
compiling the first LLM and the second LLM, wherein the compiling further incorporates respective input shapes of the first LLM and the second LLM at each layer of the network structure.

3. The method of claim 1, wherein generating the first LLM and the second LLM further comprises:
setting respective cache sizes of the first LLM and the second LLM at each layer of the network structure for storing intermediate representations during inference.

4. The method of claim 1, wherein information of the chunks includes identifiers of the layers that are grouped into each chunk.

5. The method of claim 1, wherein grouping the layers of the network structure further comprises:
setting the number of layers in each chunk individually to a configurable number.

6. The method of claim 1, further comprising:
calibrating the base model prior to generating the first LLM and the second LLM.

7. The method of claim 1, wherein further comprising:
calibrating the first LLM and the second LLM individually.

8. The method of claim 1, wherein, during inference, the first LLM generates a first output token and the second LLM generates subsequent output tokens.

9. The method of claim 8, wherein, when generating the first output token, the first LLM generates a first set of intermediate representations to store in a cache for access by the second LLM, and the first set of intermediate representations includes an output from each layer of the first LLM.

10. The method of claim 8, wherein, when generating each subsequent output token, the second LLM obtains prior cached intermediate representations and generates a subsequent set of intermediate representations to be concatenated to the prior cached intermediate representations.

11. A system for generating fixed-shaped large language models (LLMs) that perform dual-mode inference, comprising:
a plurality of processors; and
a memory coupled to the processors, wherein one or more of the processors are operative to:
quantize a base model of dynamic shapes;
generate a first LLM and a second LLM from the base model after the quantizing, the first LLM having a fixed input shape greater than one, the second LLM having a fixed input shape of one, and the first LLM and the second LLM having a same network structure and same weights;
group layers of the network structure into a plurality of chunks, wherein the number of layers in each chunk is determined by a size limit of a target device memory that loads the chunks during inference; and
compile the first LLM and the second LLM for inference time execution of an LLM task on a target device, wherein the compiling incorporates information of the chunks.

12. The system of claim 11, wherein, wherein generating the first LLM and the second LLM, the one or more of the processors are further operative to:
set the fixed input shape of the first LLM to N at each layer of the network structure, N>1;
set the fixed input shape of the second LLM to 1 at each layer of the network structure; and
compile the first LLM and the second LLM, wherein the compiling further incorporates respective input shapes of the first LLM and the second LLM at each layer of the network structure.

13. The system of claim 11, wherein, when generating the first LLM and the second LLM, the one or more of the processors are further operative to:
set respective cache sizes of the first LLM and the second LLM at each layer of the network structure for storing intermediate representations during inference.

14. The system of claim 11, wherein information of the chunks includes identifiers of the layers that are grouped into each chunk.

15. The system of claim 11, wherein, when grouping the layers of the network structure, the one or more of the processors are further operative to:
set the number of layers in each chunk individually to a configurable number.

16. The system of claim 11, wherein, when quantizing the base model, the one or more of the processors are further operative to:
calibrate the base model prior to generating the first LLM and the second LLM.

17. The system of claim 11, wherein, when quantizing the base model, the one or more of the processors are further operative to:
calibrate the first LLM and the second LLM individually.

18. The system of claim 11, wherein, during inference, the first LLM generates a first output token and the second LLM generates subsequent output tokens.

19. The system of claim 18, wherein, when generating the first output token, the first LLM generates a first set of intermediate representations to store in a cache for access by the second LLM, and the first set of intermediate representations includes an output from each layer of the first LLM.

20. The system of claim 18, wherein, when generating each subsequent output token, the second LLM obtains prior cached intermediate representations and generates a subsequent set of intermediate representations to be concatenated to the prior cached intermediate representations.
